(19) United States
(12) Patent Application Publication
(10) Pub. No.: US 2010/0026416 A1
(43) Pub. Date: Feb. 4, 2010

(54) POWER DIVIDER AND POWER COMBINER USING DUAL BAND-COMPOSITE RIGHT/LEFT HANDED TRANSMISSION LINE

(76) Inventors: Byung Hoon Ryou, Seoul (KR); Won Mo Sung, Gyeonggi-do (KR); Dong Ryul Shin, Daegu (KR); Chang Hyun Park, Incheon (KR); Jeong Pyo Kim, Seoul (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/519,520

(22) PCT Filed: Dec. 27, 2007
(86) PCT No.: PCT/KR07/06872

§ 371 Date: Sep. 28, 2009

(30) Foreign Application Priority Data
Dec. 29, 2006 (KR) 10-2006-013543

(51) Int. Cl. H01P 5/12

(52) U.S. Cl. 333/125; 333/100

(57) ABSTRACT

The present invention relates to a power divider and a power combiner employing dual band-Composite Right/Left-Handed (CRLH) transmission lines. A power divider including an input terminal and two output terminals according to the present invention includes two transmission lines each having two terminals connected to the input terminal and the output terminals, respectively, and two short-stubs having one terminals connected to the output terminals, respectively, and the other terminals connected to grounds. The transmission line may employ a first dual band-CRLH transmission line having a double value of a termination impedance, which is substantially connected to the output terminal, as a characteristic impedance, and the short-stub may employ a second dual band-CRLH transmission line, which has substantially the same value as that of the termination impedance as a characteristic impedance. The first dual band-CRLH transmission line and the second dual band-CRLH transmission line generate phase delay of 90 degrees in a high frequency band and phase delay of −90 degrees in a low frequency band with respect to an input signal.

### TECHNICAL FIELD

The present invention relates to a power divider and a power combiner employing dual band-Composite Right/Left-Handed (CRLH) transmission lines, and more particularly, to a power divider and a power combiner, which can solve a limited operating frequency and a stop band characteristic problem due to a wide band by improving the stop band characteristic of a Wilkinson power divider/combiner using dual band-CRLH transmission lines.

### BACKGROUND ART

A power divider is a circuit for dividing input power according to a specific ratio and dividing them to output ports in a Radio Frequency (RF) circuit. The power divider can divide power at a desired ratio without power loss and isolate between-the output ports, thereby ideally preventing a change in the circuit characteristic due to mutual influence of both ports. The power divider can also be used as a power combiner by switching input/output ports.

A Wilkinson power divider has been widely used as a conventional power divider/combiner. In general, a designer designs the Wilkinson power divider to have a desired frequency band using a transmission line having a Right-Handed (RH) characteristic. The Wilkinson power divider is a microwave element used to sum or divide two signals.

FIG. 1 is a schematic circuit diagram of a Wilkinson power divider in the prior art. Referring to FIG. 1, a Wilkinson power divider 100 includes an input terminal 101 and two output terminals 102, 103. Power input to the input terminal 101 is divided into the output terminals 102, 103 in the same ratio. Characteristic impedance ZOT of transmission lines 104, 105 is set

Z_{OT}=\sqrt{2}Z_{O}

and has a value of 70.7Ω. ZO refers to termination impedance of the output terminals 102, 103. The length of the transmission lines 104, 105 is set to λ/4 when the operating wavelength of the circuit is λ. Further, a resistor 106 has 100Ω, which is twice the termination impedance (that is, 2ZO).

This Wilkinson power divider is implemented using RH transmission lines and therefore has a size proportional to its wavelength. Thus, the size of the Wilkinson power divider is very large in a low frequency band and can be reused only in a frequency band, which is multiplied in a designed frequency. The Wilkinson power divider is also problematic in that it has a poor stop band characteristic because of a wide band characteristic.

As a prior art for solving the problems, there was proposed CRLH, which is a combination of a RH transmission line and a Left-Handed (LH) transmission line. FIG. 2 is a schematic circuit diagram of a Wilkinson power divider employing CRLH in the prior art. FIG. 3 illustrates insertion loss and the reflection coefficient of the Wilkinson power divider in the prior art. A Wilkinson power divider 200 is identical to the Wilkinson power divider 100 shown in FIG. 1, but includes CRLH 201 instead of the transmission lines 104, 105.

This CRLH 201, in particular, a dual band-CRLH designed to have a dual band characteristic enabled the use at a specific dual band. However, as can be seen from the graph 300 of FIG. 3, the proposed CRLH has a problem in that it does not improve the existing stop band characteristic problem due to the wide band characteristic of the Wilkinson power divider.

### DISCLOSURE OF INVENTION

### Technical Problem

Accordingly, the present invention has been made in view of the above problems occurring in the prior art, and an object of the present invention is to propose a new technology associated with a power divider employing dual band-CRLH transmission lines.

Another object of the present invention is to implement a Wilkinson power divider employing dual band-CRLH transmission lines so that it can have a dual band operating characteristic desired by a designer.

Still another object of the present invention is to solve a limited operating frequency problem and a stop band characteristic problem due to a wide band by improving the stop band characteristic through short-stubs employing dual band-CRLH transmission lines.

### Technical Solution

To achieve the above objects, a power divider including an input terminal and two output terminals according to an embodiment of the present invention includes two transmission lines each having two terminals connected to the input terminal and the output terminals, respectively, and two short-stubs having one terminals connected to the output terminals, respectively, and the other terminals connected to grounds.

According to an aspect of the present invention, the transmission line may include a first dual band-CRLH transmission line having a double value of a termination impedance, which is substantially connected to the output terminal, as a characteristic impedance, and the short-stub may include a second dual band-CRLH transmission line, which has substantially the same value as that of the termination impedance as a characteristic impedance.

*According to another aspect of the present invention, the first dual band-CRLH transmission line and the second dual band-CRLH transmission line may generate phase delay of 90 degrees in a high frequency band and phase delay of −90 degrees in a low frequency band with respect to an input signal.

According to still another aspect of the present invention, each of the first dual band-CRLH transmission line and the second dual band-CRLH transmission line may include at least one cells that can be equalized as a combination of a RH transmission line including two serial inductors and a parallel capacitor, and a LH transmission line including two serial capacitors and a parallel inductor. At this time, the RH transmission line may generate positive phase delay in a high frequency band with respect to an input signal, and the LH transmission line may generate negative phase delay in a low frequency band with respect to the input signal.

A power combiner including an output terminal and two input terminals according to another embodiment of the present invention includes two transmission lines each having two terminals connected to the input terminals, respectively, and the output terminal, and two short-stubs having one terminals connected to the input terminals, respectively, and the other terminals connected to grounds.

### ADVANTAGEOUS EFFECTS

In accordance with the present invention, a Wilkinson power divider employing du al band-CRLH transmission lines can be implemented to have a dual band operating characteristic desired by a designer.

In accordance with the present invention, the limited operating frequency problem and the stop band characteristic problem due to a wide band can be solved by improving the stop band characteristic through short-stubs employing the dual band-CRLH transmission lines.

### BRIEF DESCRIPTION OF THE DRAWINGS

Further objects and advantages of the invention can be more fully understood from the following detailed description taken in conjunction with the accompanying drawings in which:

FIG. 1 is a schematic circuit diagram of a Wilkinson power divider in the prior art;

FIG. 2 is a schematic circuit diagram of a Wilkinson power divider employing CRLH in the prior art;

FIG. 3 is a graph showing insertion loss and the reflection coefficient of the Wilkinson power divider in the prior art;

FIG. 4 is a circuit diagram of a power divider according to an embodiment of the present invention;

FIG. 5 illustrates an internal construction of a cell constituting a dual band-CRLH transmission line according to an embodiment of the present invention; and

FIG. 6 is a graph showing an example of insertion loss, isolation and the reflection coefficient of a power divider according to the present invention.

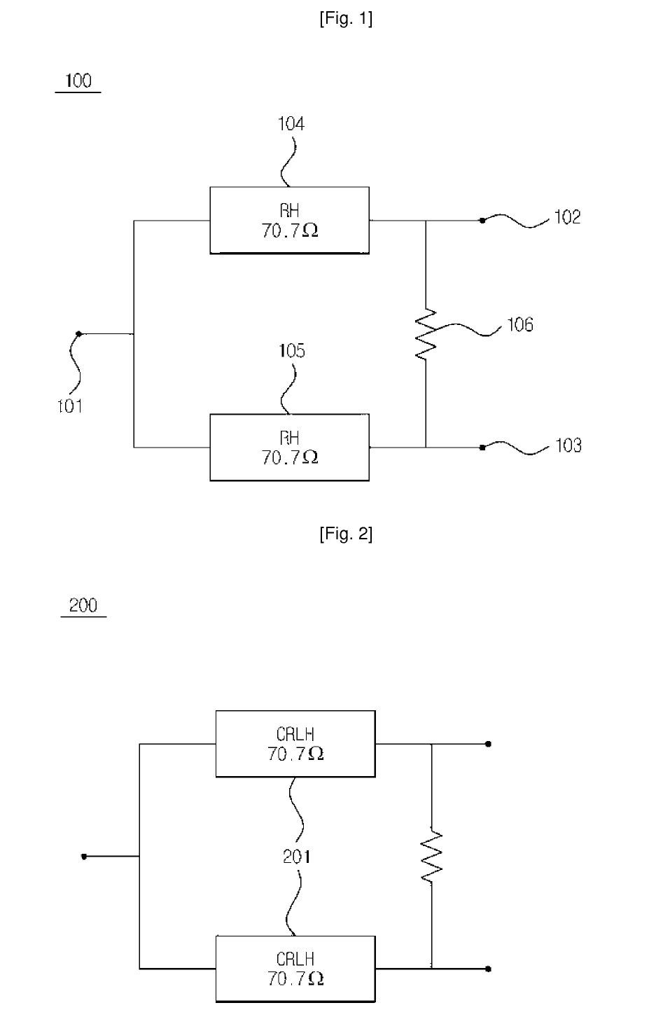

### BEST MODE FOR CARRYING OUT THE INVENTION

The present invention will now be described in detail in connection with specific embodiments with reference to the accompanying drawings. In the specification, the term “connection” refers to that two elements are connected electrically, but also refers to a case where a passage along which electrons can move is formed between two elements even though a third element is intervened between the two elements. Further, the term “transceiver” refers to an apparatus that transmits or receives RF signals, but includes both a transmitter and a receiver. In addition, in the following description, a power divider is described, but can also be applied to a power combiner correspondingly.

The present invention relates to a Wilkinson power divider, which can be used in a dual frequency band desired by a designer and has an improved stop band characteristic, and relates to a power divider that is able to solve a limited operating frequency problem and a stop band characteristic problem due to a wide band by improving the stop band characteristic of the Wilkinson power divider by employing a dual band-CRLH transmission line.

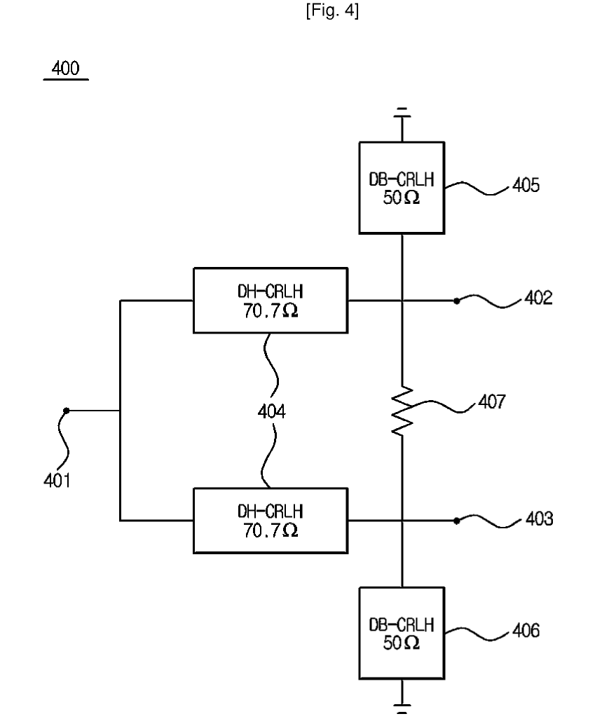

FIG. 4 is a circuit diagram of a power divider according to an embodiment of the present invention. A power divider 400 can include, as shown in FIG. 4, one input terminal 401, two output terminals 402, 403, two transmission lines 404, short-stubs 405, 406 and a resistor 407. FIG. 4 shows an exemplary circuit designed to improve the stop band characteristic at dual bands 900 MHz and 2.4 GHz.

Termination impedance connected to the input terminal 401 and the output terminals 402, 403 can have the value of 50Ω. The transmission lines 404 can be implemented using dual band-CRLH transmission lines respectively having a value 70.7Ω, which is

\sqrt{2}

times the termination impedance, as a characteristic impedance with respect to the termination impedance. The short-stubs 405, 406 can be constructed using dual band-CRLH transmission lines respectively having a characteristic impedance of 50Ω, which is identical to the termination impedance. Further, the resistor 407 connecting the two output terminals 402, 403 can be constructed to have 100Ω which is twice the termination impedance. How to set the characteristic impedance of the dual band-CRLH transmission line is described later on.

The dual band-CRLH transmission lines constituting the transmission lines 404 and the short-stubs 405, 406 can be designed to have a dual band characteristic of a low frequency band and a high frequency band. To this end, the dual band-CRLH transmission lines can have N cells. The cells have the same electromagnetic characteristic. Specifically, the dual band-CRLH transmission lines may be designed to have phase delay of 90 degrees in the low frequency band and 90 degrees in the high frequency band. In other words, in the low frequency band, the phase is advanced by 90 degrees by the CRHL transmission line, and in the high frequency band, the phase is delayed by 90 degrees by the CRHL transmission line, so the same effects as those of the conventional power divider can be accomplished. The phase characteristic of each cell 500 and the number N of the cells 500 constituting the transmission lines can be set to realize this phase delay. This is described later on.

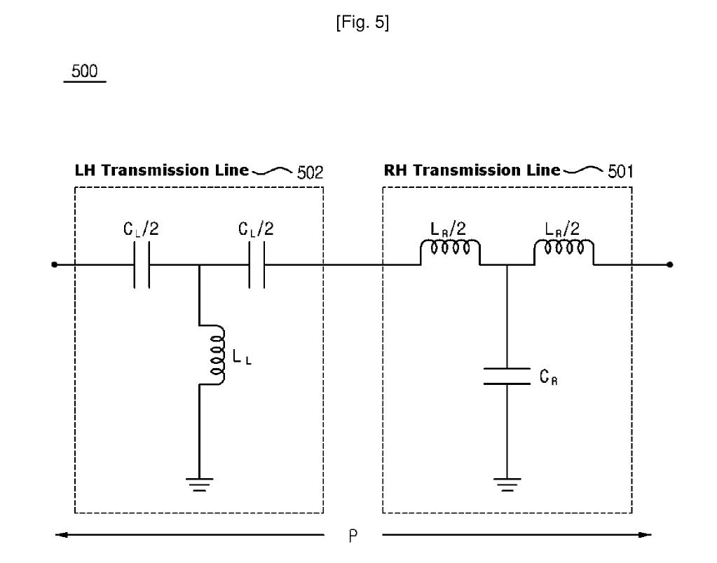

FIG. 5 illustrates an internal construction of a cell constituting a dual band-CRLH transmission line according to an embodiment of the present invention. The cell 500 largely includes a LH transmission line 502 including two serial capacitors and a parallel inductor, and a RH transmission line 501 including two serial inductors and a parallel capacitor. The RH transmission line 501 can be implemented using a transmission line, that is, a distributed element such as a microstrip, and the LH transmission line 502 can be implemented using a LC lumped element. Although it has been shown that the cell 500 includes a combination of the two separate transmission lines 501, 502, the RH transmission line 501 may be implemented substantially in the form of a transmission line connecting lumped elements simply constituting the LH transmission line 502.

The characteristic impedance and phase characteristic of the cell 500 are described hereinafter. As shown in FIG. 5, a propagation constant βCRLH of the cell 500 can be expressed in the following Mathematical Formula 1 approximately.

$${β}_{CRLH} \approx \pm ω \sqrt{( {L}_{R} - \frac{1}{{ω}^{2} {C}_{L} p} ) ( {C}_{R} - \frac{1}{{ω}^{2} {L}_{L} p} )} \qquad MathFigure 1$$

where
ω
designates the angular frequency and P designates the size of a cell.

As can be seen from the above formula, when the frequency is low,

### L_{L}

and

### C_{L}

have a predominant influence, and when the frequency is high,

### L_{R}

and

### C_{R}

have a predominant influence. Thus, in a low frequency, negative phase delay (−90 degrees) by the LH line is generally used and in a high frequency, positive phase delay (90 degrees) by the RH line is generally used as in the conventional power divider, so that phase delay necessary for both the bands can be accomplished. In particular, since phase advance is realized by the LH line in a low frequency band, the length of the transmission line is set irrespective of the wavelength unlike the prior art and may become ¼ of the wavelength of a low frequency signal. On the other hand, since phase delay is generally realized by the RH line in a high frequency, the length of the transmission line becomes ¼ of a high frequency signal wavelength. However, since the wavelength of a low frequency signal is longer, the miniaturization of a circuit can be still achieved by the use of the LH line.

Further, from the above formula, in the two use frequencies, the inductance

### L_{L}

, the capacitance

### C_{L}

, the length of the transmission line (that is,

### L_{R}

and

### C_{R}

thereby), and the number N of cells for making a phase delay Φ_{CRLH} 90 degrees (π/2) or −90 degrees (−π/2) can be decided. In particular, when the LH transmission line 502 and the RH transmission line 501 of the cell 500 are matched, that is, when

$$\sqrt{\frac{{L}_{R}}{{C}_{R}}} = \sqrt{\frac{{L}_{L}}{{C}_{L}}} ,$$

the capacitance and inductance of the LH transmission line can be expressed in the following Mathematical Formulas 2 and 3.

$$\begin{matrix}{L}_{L} = \frac{N \cdot {Z}_{O} \{ 1 - {( \frac{{f}_{1}}{{f}_{2}} )}^{2} \}}{2 π \cdot {f}_{1} \{ ( \frac{π}{2} + ( \frac{π}{2} \cdot \frac{{f}_{1}}{{f}_{2}} ) \}} & MathFigure 2 \\ {C}_{L} = \frac{N \{ 1 - ( \frac{{f}_{1}}{{f}_{2}} ) \}}{2 π \cdot {Z}_{O} \{ ( \frac{π}{2} + ( \frac{π}{2} \cdot \frac{{f}_{1}}{{f}_{2}} ) \}} & MathFigure 3\end{matrix}$$

In the Mathematical Formulas 2 and 3,

f₁
and
f₂
designate the central frequencies of low and high frequency, respectively, and

### Z_{O}

designates characteristic impedance of the transmission line.

### Z_{O}

may have 70.7Ω with respect to the transmission line 404 and 50Ω with respect to the short-stub 405. Thus, the transmission line 404 and the short-stub 405 can be implemented using the cell 500. In particular, when
f₁
is very smaller than
f₂
,
f₁
can be mainly adjusted freely by controlling the value of

### L_{L}

As an example of the cell 500, each of the two serial capacitors can employ capacitance C_{L}/2 and the parallel inductor can employ an inductance L_{L}, as shown in FIG. 5.

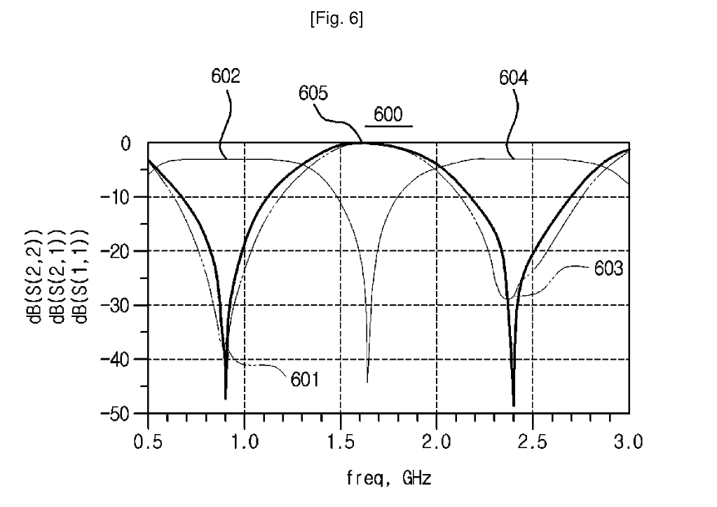

FIG. 6 is a graph showing an example of insertion loss (thin solid line), isolation (thick solid line) and the reflection coefficient (wavy line) of the power divider according to the present invention. From a graph 600 shown in FIG. 6, it can be seen that the isolation according to the power divider has a very small value ranging from 900 MHz and 2.4 GHz to −45 dB or less. In other words, it can be seen that the isolation between the two output terminals is excellent.

It can also be seen that the reflection coefficient 601 is −36.743 dB and the insertion loss 602 approaches −3 dB at a frequency band of 900 MHz (that is, a low frequency band) and, therefore, power is divided accurately between the two output terminals. Further, it can be seen that the reflection coefficient 603 is −27.717 dB and the insertion loss 604 approaches −3 dB even at a frequency band of 2.4 GHz (that is, a high frequency band) and, therefore, power is halved accurately between the two output terminals even in the high frequency band.

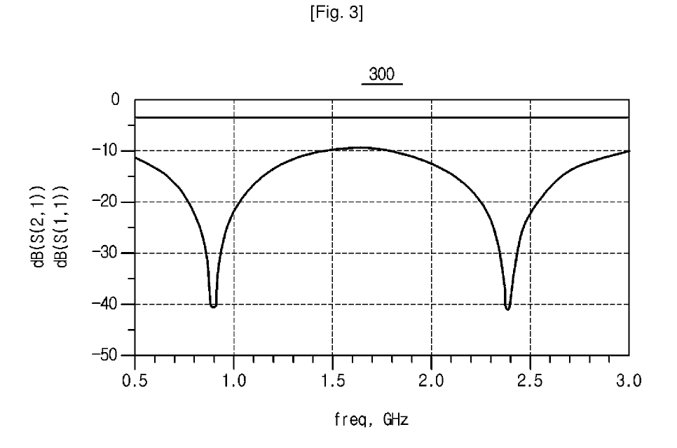

Meanwhile, in a stop band between the frequency bands 900 MHz and 2.4 GHz, the isolation and the reflection coefficient 605 are greatly increased near 0 dB. Thus, it was found that the power divider of the present invention has an excellent stop band characteristic when compared with the conventional power divider (refer to FIG. 3) having the reflection coefficient of −3 dB or less.

If the power divider according to the present invention is employed as described above, a Wilkinson power divider employing the CRHL transmission line can be implemented to have a dual band operating characteristic desired by a designer. Further, the limited operating frequency problem and the stop band characteristic problem due to a wide band can be solved by improving the stop band characteristic through short-stubs employing the dual band-CRLH transmission line.

As described above, the present invention has been described with reference to specific items, such as detailed constituent elements, restricted embodiments and drawings, but they are provided in order to help overall understanding of the present invention. The present invention is not limited to the above embodiments, but can be changed and modified in various ways by those having ordinary skill in the art from the above description. For example, it should be understood that any constituent elements described as the lumped element in the specification can be implemented using a distributed constant circuit, and vice versa. It is also to be noted that any constituent elements described as the lumped element in the specification are included in the scope of the present invention if they can be equalized as a circuit described in the specification irrespective of a detailed construction of the circuit.

Although the specific embodiments of the present invention have been disclosed for illustrative purposes, those skilled in the art will appreciate that various modifications, additions and substitutions are possible, without departing from the scope and spirit of the invention as disclosed in the accompanying claims.

Accordingly, it is to be understood that the invention is not limited to the disclosed embodiments, but, on the contrary, is intended to cover various modifications and equivalent arrangements included within the spirit and scope of the appended claims.

1. A power divider including an input terminal and two output terminals, comprising:
two transmission lines each having two terminals connected to the input terminal and the output terminals, respectively; and
two short-stubs having one terminals connected to the output terminals, respectively, and the other terminals connected to grounds.

2. The power divider of claim 1, wherein:
the transmission line comprises a first dual band-Composite Right/Left Handed (CRLH) transmission line having a double value of a termination impedance, which is substantially connected to the output terminal, as a characteristic impedance, and
the short-stub comprises a second dual band-CRLH transmission line, which has substantially the same value as that of the termination impedance as a characteristic impedance.

3. The power divider of claim 2, wherein the first dual band-CRLH transmission line and the second dual band-CRLH transmission line generate phase delay of 90 degrees in a high frequency band and phase delay of −90 degrees in a low frequency band with respect to an input signal.

4. The power divider of claim 2, w herein each of the first dual band-CRLH transmission line and the second dual band-CRLH transmission line includes at least one cells that can be equalized as a combination of a RH transmission line including two serial inductors and a parallel capacitor, and a LH transmission line including two serial capacitors and a parallel inductor.

5. The power divider of claim 4, wherein:
the RH transmission line generates positive phase delay in a high frequency band with respect to an input signal, and
the LH transmission line generates negative phase delay in a low frequency band with respect to the input signal.

6. A transceiver comprising:
a power divider comprising:
an input terminal;
two output terminals;
two transmission lines each having two terminals connected to the input terminal and the output terminals respectively; and
two short-stubs having one terminals connected to the output terminals, respectively and the other terminals connected to grounds.

7. A power combiner including an output terminal and two input terminals, comprising:
two transmission lines each having two terminals connected to the input terminals, respectively, and the output terminal; and
two short-stubs having one terminals connected to the input terminals, respectively, and the other terminals connected to grounds.

8. The power combiner of claim 7, wherein:
the transmission line comprises a first dual band-CRLH transmission line having a double value of a termination impedance, which is substantially connected to the input terminal, as a characteristic impedance, and
the short-stub comprises a second dual band-CRLH transmission line, which has substantially the same value as that of the termination impedance as a characteristic impedance.

9. The power combiner of claim 8, wherein the first dual band-CRLH transmission line and the second dual band-CRLH transmission line generate phase delay of 90 degrees in a high frequency band and phase delay of −90 degrees in a low frequency band with respect to an input signal.

10. The power combiner of claim 8, wherein each of the first dual band-CRLH transmission line and the second dual band-CRLH transmission line includes at least one cells that can be equalized as a combination of a RH transmission line including two serial inductors and a parallel capacitor, and a LH transmission line including two serial capacitors and a parallel inductor.

11. The power combiner of claim 10, wherein:
the RH transmission line generates positive phase delay in a high frequency band with respect to an input signal, and
the LH transmission line generates negative phase delay in a low frequency band with respect to the input signal.

12. A transceiver including the power combiner according to comprising:
a power combiner comprising:
an output terminal;
two input terminals;
two transmission lines each having two terminals connected to the input terminals, respectively and the output terminal; and
two short-stubs having one terminals connected to the input terminals, respectively and the other terminals connected to the grounds.
